(19) United States
(12) Patent Application Publication
(10) Pub. No.: US 2007/0010644 A1
(43) Pub. Date: Jan. 11, 2007

(54) Elastomeric urethane composition

(75) Inventors: John Erickson, Southgate, MI (US); Calvin T. Peeler, Canton, MI (US)

Correspondence Address: BASF AKTIENGESELLSCHAFT, CARL-BOSCH STRASSE 38, 67056 LUDWIGSHAFEN, LUDWIGSHAFEN, 69056, DE

(73) Assignee: BASF Corporation.

(21) Appl. No.: 11/177,196

(22) Filed: Jul. 8, 2005

(51) Int. Cl. C08G 18/16

(52) U.S. Cl. 528/48

(57) ABSTRACT

An elastomeric urethane composition includes the reaction product of a resin composition, including a polyol, and an isocyanate. The resin composition and the isocyanate are reacted, in the presence of a first and a second catalyst, to form a polyurethane elastomer. The first catalyst includes a metal selected from the group of iron, titanium, zirconium and hafnium. The second catalyst includes an amine. The elastomeric urethane composition may be used in a method of making an article. The method includes reacting the resin composition and the isocyanate to form the elastomeric urethane composition, applying the elastomeric urethane composition to a mold cavity, and allowing the elastomeric urethane composition to cure to form a first layer. The method also includes applying a urethane composition, different from the elastomeric urethane composition, to the mold to form a second layer, curing the article in the mold, and de-molding the article from the mold.

### FIELD OF THE INVENTION

The present invention generally relates to an elastomeric urethane composition used to form a polyurethane elastomer. The invention also relates to a method of forming an article from the elastomeric urethane composition. More specifically, the present invention relates to an elastomeric urethane composition that includes the reaction product of a resin composition and an isocyanate, in the presence of a first and a second catalyst.

### DESCRIPTION OF THE RELATED ART

Various elastomeric urethane compositions have been investigated for use in industrial processes to form polyurethane elastomers. Polyurethane elastomers are non-foamed and can be used in a wide variety of applications including both automotive and non-automotive components. Polyurethane elastomers include the reaction product of a polyol and an isocyanate reactive with the polyol. In the past, unsuccessful efforts have been made to reduce levels of volatile organic compounds (VOCs) associated with formation of the polyurethane elastomers and to reduce production costs.

The VOCs typically include organic compounds that evaporate into the air including catalysts, UV absorbers, hindered amine light stabilizers, antioxidants, styrenes, glycols, ethers, esters, and ketones. Reduction of VOCs, in general, is desirable to reduce potential environmental pollution that may accompany their use. More specifically, reduction of VOCs is especially desirable in automotive applications to reduce odors in a passenger compartment of an automobile and to increase customer satisfaction.

The production costs include money spent on raw materials, costs for controlling an amount of water and humidity in storage vessels and a production environment to ensure an efficient cure of the polyurethane elastomer, and time expended on inefficient reactions of the polyol and the isocyanate.

As is well known in the art, the reaction of the polyol and the isocyanate typically proceeds slowly, thereby decreasing a cost effectiveness of the reaction. As a result, many catalysts have been used to increase a rate of the reaction. The catalysts include organotin compounds, zinc carboxylates, bismuth carboxylates, and organomercury compounds. Although effective, these catalysts are toxic and require expensive disposal, further contributing to production costs.

Many of these catalysts not only increase the rate of the reaction of polyol and the isocyanate, but also catalyze a reaction of the isocyanate with any water and humidity present in the production environment, which is undesirable. Water and humidity, if present, are known to react with the isocyanate to form gaseous carbon dioxide. The formation of gaseous carbon dioxide leads to a formation of voids and blisters in the polyurethane elastomer, which decrease structural integrity and density of the polyurethane elastomer. As such, production costs associated with forming the polyurethane elastomers are also high due to the need for removing water and humidity from the production environment.

Many of these catalysts are also deactivated when exposed to water and humidity. As a result, any water or humidity present in the production environment not only reacts with the isocyanate, but also deactivates the catalyst and prevents any further use of the catalyst. This potential deactivation of the catalyst requires more catalyst to be used in the reaction of the polyol and the isocyanate. Consequently, using more catalyst in the reaction increases production costs.

Efforts have also been made to simultaneously reduce an effect of water and humidity present in the production environment and to reduce production costs. One effort is disclosed in U.S. Pat. No. 5,965,686 to Blank et al. The '686 patent discloses use of a catalyst that includes zirconium or hafnium. The '686 patent also discloses that the catalyst effectively catalyzes the reaction of the polyol and the isocyanate while not effectively catalyzing the reaction of water and the isocyanate. Although the '686 patent discloses useful advances in catalyst technology, the '686 patent does not teach using a combination of an amine catalyst and a catalyst including a metal such as iron, titanium, zirconium or hafnium as a way to reduce production costs, to improve durability, density, usefulness and marketability of the polyurethane elastomer, or to reduce VOCs. As such, there remains an opportunity to utilize an amine catalyst and a catalyst including a metal such as iron, titanium, zirconium, or hafnium to form a polyurethane elastomer that is durable and marketable, while reducing production costs.

### SUMMARY OF THE INVENTION AND ADVANTAGES

The present invention provides an elastomeric urethane composition. The elastomeric urethane composition includes the reaction product of a resin composition and an isocyanate. The resin composition includes a polyol. The resin composition and the isocyanate are reacted in the presence of a first catalyst comprising a metal selected from the group of iron, titanium, zirconium and hafnium, and a second catalyst comprising an amine, to preferably form a polyurethane elastomer. The present invention also provides an elastomeric urethane system. The elastomeric urethane system includes the resin composition, the isocyanate, and the first and second catalysts described above.

The present invention further provides a method of making an article in a mold having a mold cavity. The method includes reacting the resin composition and the isocyanate in the presence of the first catalyst and the second catalyst, to form the elastomeric urethane composition. The method also includes applying the elastomeric urethane composition to the mold cavity and allowing the elastomeric urethane composition to cure to form a first layer. The method also includes applying a urethane composition, different from the elastomeric urethane composition described above, to the mold cavity to form a second layer. The method further includes curing the article in the mold cavity and demolding the article from the mold cavity.

The first catalyst, including the metal selected from the group of iron, titanium, zirconium and hafnium, has a high catalytic efficiency for the reaction of the polyol and the isocyanate. The high catalytic efficiency increases the rate of the reaction, i.e., decreases a gel time. Consequently, the elastomeric urethane composition can be sprayed while minimizing dripping that accompanies spraying the polyol and isocyanate when these components are not reacted or when these components are reacting slowly. When dripping is minimized, the elastomeric urethane composition is used more efficiently, thereby further reducing production costs. An increased rate of reaction also allows the elastomeric urethane composition to be sprayed and the polyurethane elastomer to be de-molded in a short period of time further reducing production costs associated with time spent waiting for de-molding.

The first catalyst also has a decreased sensitivity to water and humidity present in a production environment and is, therefore, not quickly deactivated when exposed to water and humidity. Also, less catalyst is required for use in the reaction, and costs are therefore reduced. The first catalyst does not effectively catalyze an undesired side reaction of water with the isocyanate that forms gaseous carbon dioxide. As such, the polyurethane elastomer has structural integrity and a sufficient density which will lead to increased marketability.

The first catalyst is substantially free of volatile organic compounds (VOCs). This minimization of VOCs reduces potential environmental pollution that may accompany their use and reduces potential odors from use of the elastomeric urethane composition in a passenger compartment of an automobile, which increases customer satisfaction.

The second catalyst allows the amount of more expensive catalysts, such as the first catalyst, to be reduced. If the amount of the more expensive catalysts is reduced, the overall production costs are also reduced. The present invention utilizes a dynamic interaction between the first and the second catalysts to preferably form the polyurethane elastomer. As such, the catalysts are preferably balanced to achieve desirable properties in the polyurethane elastomer.

The dynamic interaction between the first and the second catalysts decreases a paint adhesion time and a de-molding time, and facilitates a formation of the polyurethane elastomer having improved tensile strength, Graves Tear Strength, and elongation. An improved tensile strength of the polyurethane elastomer reduces a chance that the polyurethane elastomer may fail. An improved Graves Tear Strength of the polyurethane elastomer reduces a possibility that the polyurethane elastomer may tear. Increasing elongation of the polyurethane elastomer improves flexibility. Improved tensile strength and Graves Tear Strength in addition to elongation, of the polyurethane elastomer, increase marketability of the polyurethane elastomer.

### BRIEF DESCRIPTION OF THE DRAWINGS

FIG. 1 is a distribution graph illustrating original tensile strength of Polyurethane Elastomers 25 through 29, in pounds per square inch at room temperature.

FIG. 2 is a distribution graph illustrating original tensile strength of Polyurethane Elastomers 30 through 34, in pounds per square inch at room temperature.

FIG. 3 is a distribution graph illustrating tensile strength of Polyurethane Elastomers 25 through 29, in pounds per square inch after the polyurethane elastomers were heat treated for 500 hours at 250° F.

FIG. 4 is a distribution graph illustrating tensile strength of Polyurethane Elastomers 30 through 34, measured in pounds per square inch after the polyurethane elastomers were heat treated for 500 hours at 250° F.

FIG. 5 is a distribution graph illustrating original elongation of Polyurethane Elastomers 25 through 29, measured in percent at room temperature.

FIG. 6 is a distribution graph illustrating original elongation of Polyurethane Elastomers 30 through 34, measured in percent at room temperature.

FIG. 7 is a distribution graph illustrating elongation of Polyurethane Elastomers 25 through 29, measured in percent after the polyurethane elastomers were heat treated for 500 hours at 250° F.

FIG. 8 is a distribution graph illustrating elongation of Polyurethane Elastomers 30 through 34, measured in percent after the polyurethane elastomers were heat treated for 500 hours at 250° F.

FIG. 9 is a distribution graph illustrating original Graves Tear Strength of Elastomers 25 through 29, measured in pounds per linear inch at room temperature.

FIG. 10 is a distribution graph illustrating original Graves Tear Strength of Polyurethane Elastomers 30 through 34, measured in pounds per linear inch at room temperature.

FIG. 11 is a distribution graph illustrating Graves Tear Strength of Polyurethane Elastomers 25 through 29, measured in pounds per linear inch after the polyurethane elastomers were heat treated for 500 hours at 250° F.

FIG. 12 is a distribution graph illustrating Graves Tear Strength of Polyurethane Elastomers 30 through 34, measured in pounds per linear inch after the polyurethane elastomers were heat treated for 500 hours at 250° F.

### DETAILED DESCRIPTION OF A PREFERRED EMBODIMENT

An elastomeric urethane composition, according to the present invention, includes the reaction product of a resin composition, including a polyol, and an isocyanate, reactive with the resin composition. The resin composition and the isocyanate react in the presence of a first and a second catalyst, preferably to form a polyurethane elastomer. Without intending to be limited by any particular theory, it is believed that the primary reactions occur between the polyol and short-chain chain extenders, which are components of the resin composition with the isocyanate. It is also believed that the first and the second catalysts effectively combine in a dynamic interaction to facilitate formation of the polyurethane elastomer having a decreased paint adhesion time, a decreased de-molding time, and improved physical properties. The resin composition, the polyol, the isocyanate, and the first and second catalysts are described in greater detail below.

The polyurethane elastomer of the present invention is not foamed. Any foaming that occurs is not desired, is preferably minimized and is most preferably eliminated. The polyurethane elastomer may be used to form articles including automotive parts such as instrument panels, door bolsters, and various other interior trim components. The polyurethane elastomer may also be used in industrial applications such as: coatings, foams, adhesives, sealants, and in reaction injection molded plastics. In one embodiment of the present invention, the polyurethane elastomer is used to form a door bolster in an automobile. This embodiment of the present invention will also be described in greater detail below.

Referring now to the polyol first introduced above, the polyol is preferably selected from the group of polyetherols, polyesterols, polycaprolactones and combinations thereof. Most preferably the polyol includes a polyetherol. The polyol is preferably formed from a reaction of an initiator and an alkylene oxide. Preferably, the initiator is selected from the group of aliphatic initiators, aromatic initiators, aminic initiators, and combinations thereof. More preferably, the initiator is selected from the group of ethylene glycol, propylene glycol, dipropylene glycol, trimethylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, glycerol, 1,1,1-trimethylolpropane, 1,1,1-trimethylolethane, 1,2,6-hexanetriol, α-methyl glucoside, pentaerythritol, sorbitol, aniline, o-chloroaniline, p-aminoaniline, 1,5-diaminonaphthalene, methylene dianiline, the condensation products of aniline and formaldehyde, 2,3-, 2,6-, 3,4-, 2,5-, and 2,4-diaminotoluene and isomeric mixtures, methylamine, triisopropanolamine, ethylenediamine, 1,3-diaminopropane, 1,3-diaminobutane, 1,4-diaminobutane, monoethanolamine, diethanolamine, triethanolamine, and combinations thereof. Most preferably, the initiator is selected from the group of glycerol, 1,1,1-trimethylolpropane, and combinations thereof. However, it is contemplated that any suitable initiator known in the art may be used in the present invention.

Preferably, the alkylene oxide that reacts with the initiator to form the polyol is selected from the group of ethylene oxide, propylene oxide, butylene oxide, amylene oxide, tetrahydrofuran, alkylene oxide-tetrahydrofuran mixtures, epihalohydrins, aralkylene oxides, and combinations thereof. More preferably, the alkylene oxide is selected from the group of ethylene oxide, propylene oxide, and combinations thereof. Most preferably, the alkylene oxide includes propylene oxide. However, it is also contemplated that any suitable alkylene oxide that is known in the art may be used in the present invention.

The polyol also preferably includes an alkylene oxide cap. It is to be understood that the terminology “cap” refers to a terminal portion of the polyetherol. Preferably the alkylene oxide cap includes ethylene oxide, propylene oxide, butylene oxide, amylene oxide, and combinations thereof. More preferably, the alkylene oxide cap includes ethylene oxide. Preferably, the alkylene oxide cap is of from 5 to 20, more preferably of from 10 to 20, even more preferably of from 12 to 20, and most preferably of from 12 to 18, percent by weight based on the total weight of the polyol. Without intending to be bound by theory, it is believed that the alkylene oxide cap promotes an increase in a rate of the reaction, i.e., decreases a gel time, of the polyol and the isocyanate. As such, the alkylene oxide cap of the polyol, if included, preferably allows the elastomeric urethane composition to be effectively used in impingement mixing and spraying techniques to form the polyurethane elastomer and articles formed therefrom, without dripping, contributing to a reduction of production costs.

The polyol also preferably has a number average molecular weight of from 1,500 to 10,000 g/mol. More preferably, the polyol has a number average molecular weight of from 3,000 to 8,000, and most preferably of from 4,000 to 6,500, g/mol. Without limiting the scope of the present invention, it is believed that the number average molecular weight of the polyol contributes to the flexibility of the polyurethane elastomer.

The polyol also preferably has a hydroxyl number of from 20 to 100 mg KOH/g. More preferably, the polyol has a hydroxyl number of from 20 to 50, and most preferably of from 24 to 36, mg KOH/g. The polyol also preferably has a calculated functionality of from 2 to 4. Most preferably, the polyol has a calculated functionality of 3. Further, the polyol is preferably present in the resin composition in an amount of from 60 to 80 and most preferably of from 65 to 75, parts by weight per 100 parts by weight of the resin composition. Still further, the polyol may also include an organic functional group selected from the group of a carboxyl group, an amine group, a carbamate group, an amide group, and an epoxy group. Preferred polyols for use in the present invention includes two polyols commercially available from BASF Corporation of Wyandotte, Mich., under the trade names of Pluracol® 816 and Pluracol® 538.

The elastomeric urethane composition also preferably includes a second polyol. It is contemplated that the second polyol may be present in the resin composition or may be independent from the resin composition. The second polyol, if included, is different from the polyol present in the resin composition. If the second polyol is included, the second polyol is preferably selected from the group of polyetherols, polyesterols, polycaprolactones, and combinations thereof. Most preferably, the second polyol includes a polyetherol. The second polyol is preferably formed from a reaction of a second initiator and a second alkylene oxide. The second initiator is preferably selected from the group of aliphatic initiators, aromatic initiators, aminic initiators, and combinations thereof. More preferably, the second initiator is selected from the group of ethylene glycol, propylene glycol, dipropylene glycol, trimethylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, glycerol, 1,1,1-trimethylolpropane, 1,1,1-trimethylolethane, 1,2,6-hexanetriol, α-methyl glucoside, pentaerythritol, sorbitol, aniline, o-chloroaniline, p-aminoaniline, 1,5-diaminonaphthalene, methylene dianiline, the condensation products of aniline and formaldehyde, 2,3-, 2,6-, 3,4-, 2,5-, and 2,4-diaminotoluene and isomeric mixtures, methylamine, triisopropanolamine, ethylenediamine, 1,3-diaminopropane, 1,3-diaminobutane, 1,4-diaminobutane, monoethanolamine, diethanolamine, triethanolamine, and combinations thereof. Most preferably, the second initiator includes ethylene glycol, propylene glycol, dipropylene glycol, trimethylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, and combinations thereof.

The second polyol also preferably has a number average molecular weight of from 1,500 to 10,000 g/mol. More preferably, the second polyol has a number average molecular weight of from 3,000 to 8,000, and most preferably of from 4,000 to 6,000, g/mol.

The second polyol also preferably has a hydroxyl number of from 20 to 100 mg KOH/g. More preferably, the second polyol has a hydroxyl number of from 20 to 50, and most preferably of from 24 to 36, mg KOH/g. The second polyol also preferably has a calculated functionality of from 2 to 4. Most preferably, the second polyol has a calculated functionality of 2. Further, the second polyol is preferably present in the resin composition in an amount of less than or equal to 30, and most preferably of from 10 to 20, parts by weight per 100 parts by weight of the resin composition. Still further, the second polyol may also include an organic functional group selected from the group of a carboxyl group, an amine group, a carbamate group, an ester group, an amide group, and an epoxy group. More specifically, the second polyol may also include a polycaprolactone. Examples of polycaprolactones suitable for use as the second polyol include those commercially available from Dow Chemical Company of Midland, Mich. A most preferred second polyol for use in the present invention includes a second polyol commercially available from BASF Corporation of Wyandotte, Mich., under the trade name of Pluracol® 1062.

Referring now to the isocyanate first introduced above, the isocyanate preferably includes an aromatic isocyanate, an aliphatic isocyanate, and/or combinations thereof. Most preferably, the isocyanate includes an aromatic isocyanate. If the isocyanate includes an aromatic isocyanate, the aromatic isocyanate preferably corresponds to the formula R′(NCO)_{z} wherein R′ is a polyvalent organic radical which is aromatic and z is an integer that corresponds to the valence of R′. Preferably, z is at least two. The isocyanate of the present invention is preferably aromatic because the aromaticity imparts increased reactivity towards the reaction of the isocyanate with the polyol, and a reduced cost associated with manufacture of the isocyanate.

The isocyanate may include, but is not limited to, 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisochyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, and 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and combinations thereof. A preferred example of a 4,4′-diphenylmethane diisocyanate is commercially available from BASF Corporation of Wyandotte, Mich., under the trade name of Lupranate® MM103.

If the isocyanate includes an aromatic isocyanate, the isocyanate may also include a modified multivalent aromatic isocyanate, i.e., a product which is obtained through chemical reactions of aromatic diisocyanates and/or aromatic polyisocyanates. Examples include polyisocyanates including, but not limited to, ureas, biurets, allophanates, carbodiimides, uretonimines, and isocyanurate and/or urethane groups including diisocyanates and/or polyisocyanates such as modified diphenylmethane diisocyanates. The isocyanate may also include, but is not limited to, modified benzene and toluene diisocyanates, employed individually or in reaction products with polyoxyalkyleneglycols, diethylene glycols, dipropylene glycols, polyoxyethylene glycols, polyoxypropylene glycols, polyoxypropylenepolyoxethylene glycols, polyesterols, polycaprolactones, and combinations thereof. Most preferably, in the present invention, the isocyanate is selected from the group of 2,4′-diphenylmethane diisocyanate, 4,4′-diphenylmethane diisocyanate, modified 2,4′-diphenylmethane diisocyanate, modified 4,4′-diphenylmethane diisocyanate, and combinations thereof. The isocyanate may also include stoichiometric or non-stoichiometric reaction products of the aforementioned isocyanates. A preferred example of a modified diphenylmethane diisocyanate is commercially available from BASF Corporation of Wyandotte, Mich., under the trade name of Lupranate® MP102. However, it is contemplated that in all embodiments of the present invention, any isocyanate known in the art may be used in the present invention.

The isocyanate preferably has a % NCO content of from 8 to 35, more preferably of from 10 to 30, and most preferably of from 22 to 30, percent by weight. Determination of the % NCO content on percent by weight is accomplished by a standard chemical titration analysis known to those skilled in the art. Also, the isocyanate preferably has a calculated functionality of from 1.7 to 3, more preferably of from 1.9 to 3, and most preferably of from 1.9 to 2.1. Still further, the isocyanate preferably has a viscosity of from 15 to 2000, more preferably of from 50 to 1000, and most preferably of from 50 to 700, cps at 25° C.

As first introduced above, the resin composition preferably reacts, in the presence of the first and second catalysts, with the isocyanate, to form the polyurethane elastomer. Preferably, the resin composition and the isocyanate are reacted at an isocyanate index of from 90 to 110, more preferably of from 95 to 105, and most preferably of from 99 to 101. The isocyanate index for the present invention is defined as 100 times the ratio of the number of isocyanate (NCO) groups in the isocyanate to the number of hydroxyl (OH) groups in the resin composition.

Referring now to the first catalyst, first introduced above, the first catalyst includes a metal selected from the group of iron, titanium, zirconium and hafnium. Preferably, the first catalyst increases the rate of the reaction of the polyol and the isocyanate, i.e., decreases gel time, to form the polyurethane elastomer. Preferably, the first catalyst includes the general structure: 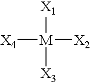
wherein M is selected from the group of iron, titanium, zirconium and hafnium and wherein each of X₁, X₂, X₃, and X₄ are ligands. More preferably, M is selected from the group of iron, titanium and zirconium. Most preferably, M is selected from the group of iron and zirconium. In all embodiments of the present invention, any iron, titanium, zirconium, and/or hafnium present in the first catalyst form iron chelates, titanium chelates, zirconium chelates, and hafnium chelates, respectively.

Preferably, each of the ligands X₁, X₂, X₃, and X₄, which may be the same or may be different, are independently selected from the group of a diketone having the general structure R¹COCHCOR². Each of R¹ and R² preferably include one of a branched or linear hydrocarbon and preferably include of from 1 to 20 carbon atoms. However, hydrocarbons having greater than 20 carbons atoms are also contemplated for use in the present invention. Preferably, each of the ligands X₁, X₂, X₃, and X₄ are 2,4-pentanedionate or 2,2,6,6-tetramethyl-3,5-heptanedionate. More preferably, at least one of the ligands X₁, X₂, X₃, and X₄ independently includes 2,4-pentanedionate.

Other examples of suitable ligands that may be used in the present invention include, but are not limited to, 6-methyl-2,4-heptanedionate, (wherein R¹=C¹ and R²=C₄), 2,4-octanedionate (wherein R¹=C₁ and R²=C₄), 2,4-nonanedionate (wherein R^{1=C}₁ and R²=C₅), 2,4-undecyldionate (wherein R¹=C₁ and R²=C₇), 2,4-dodecyldionate (wherein R¹=C₁, R²=C₈), 2,4-pentadecyldionate (wherein R¹=C₁ and R²=C₁₁), branched and unbranched isomers thereof, and combinations thereof.

The first catalyst may also include a mixture of iron, titanium, zirconium or hafnium diketonates. If the first catalyst includes a mixture of iron, titanium, zirconium or hafnium diketonates, then the iron, titanium, zirconium or hafnium diketonates preferably have at least 7 carbons. However, it is also contemplated that the iron, titanium, zirconium or hafnium diketonates may have less than 7 carbons.

The first catalyst can generally be synthesized via known ligand exchange reactions of iron, titanium, zirconium or hafnium compounds with a desired diketone. Specifically, the first catalyst may be prepared in a solution by blending iron, titanium, zirconium or hafnium with the desired ligands as chelating agents in a solution at an ambient or slightly elevated temperature. The solution may include, but is not limited to, polyols such as propylene glycol, dipropylene glycol, 1,3-butylene glycol, 1,6-hexane diol, polypropylene glycol, polytetramethylene glycol, dimethoxy-dipropylene glycol, and combinations thereof. The solution may also include, but is not limited to, diluents including alcohols, butoxy/propoxy/ethoxy polypropylene ethylene glycol ethers, acetylacetonates of iron, titanium, zirconium or hafnium, and combinations thereof. As such, the first catalyst is substantially free of VOCs and is preferably used in embodiments of the present invention such as in a passenger compartment of an automobile. It is to be understood that substantially free includes a level of VOCs preferably of less than 0.05, more preferably of less than 0.02, and most preferably of less than 0.01, parts by weight of the VOC per 100 parts by weight of the polyurethane elastomer.

The most preferred first catalyst for use in the present invention is commercially available from Sigma Aldrich, Inc. of Norwalk, Conn., under the chemical name of zirconium (IV) acetylacetonate. Preferably the first catalyst is present in the elastomeric urethane composition in an amount of from 0.025 to 0.100, more preferably in an amount of from 0.03 to 0.07, and most preferably in an amount of from 0.04 to 0.06, parts by weight of the catalyst per 100 parts by weight of the resin composition. In one embodiment of the present invention, the first catalyst is blended with the resin composition prior to reaction with the isocyanate. In another embodiment of the present invention, the first catalyst is combined with the isocyanate.

The first catalyst does not require expensive disposal because the first catalyst includes the metal selected from the group of iron, titanium, zirconium and hafnium, none of which is as highly toxic as tin or mercury. The first catalyst also has a high catalytic efficiency for the reaction of the polyol and the isocyanate. The high catalytic efficiency increases the rate of the reaction, i.e., decreases the gel time, and allows the elastomeric urethane composition to be sprayed, while minimizing dripping.

Further, the first catalyst has a decreased sensitivity to water and humidity present in the production environment and is not quickly deactivated when exposed to the water and humidity. Because of this decreased sensitivity, the humidity in the production environment does not have to be completely removed. Additionally, because the first catalyst is not quickly deactivated when exposed to water and humidity, less of the first catalyst is required for use in the reaction.

Still further, the first catalyst does not effectively catalyze an undesirable side reaction of water and humidity with the isocyanate. Reaction of water and humidity with the isocyanate forms gaseous carbon dioxide causing the polyurethane elastomer to foam, as is well known in the art. Foaming the polyurethane elastomer with the gaseous carbon dioxide is undesirable and forms voids and blisters in the polyurethane elastomer. Formation of voids and blisters results in a degradation of physical properties of the polyurethane elastomer including a weakened structural stability and a non-homogeneous density. As such, there are no chemical or physical blowing agents or expanding agents included in the elastomeric urethane composition of the present invention. The first catalyst minimizes foaming and allows the polyurethane elastomer to be formed with consistent physical properties thereby increasing a marketability of the polyurethane elastomer.

In addition to the first catalyst, the elastomeric urethane composition also includes a second catalyst that includes an amine, which is different from the first catalyst described above. The second catalyst may be blended with the resin composition prior to reaction with the isocyanate, may be present with the isocyanate, or may be present in the resin composition and with the isocyanate. Preferably, the second catalyst is present in the resin composition. Preferably, the second catalyst includes dimethylaminopropylurea, 1-ethyl-3-(3-dimethylaminopropyl)urea, 2-propenoic acid, 2-methyl-2-[[[[(3-dimethylamino)propyl]amino]carbonyl]amino]ethyl ester. More preferably, the second catalyst includes dimethylaminopropylurea that is commercially available from Air Products and Chemicals, Inc. of Allentown, Pa., under the trade name of DABCO® NE-1070. The second catalyst is preferably included in an amount of from 0.5 to 3, and most preferably of from 1 to 2, parts by weight per 100 parts by weight of the resin composition. It is to be understood that the second catalyst can decompose to form VOCs. However, this decomposition is minimal. As such, the second catalyst is still preferably used in embodiments of the present invention including in the passenger compartment of an automobile.

The second catalyst allows an amount of more expensive catalysts to be reduced. Catalysts including amines are typically less expensive than metal catalysts. The second catalyst also does not include highly toxic metals that require costly disposal.

The present invention preferably utilizes a dynamic interaction between the first and the second catalysts to preferably form the polyurethane elastomer. As such, the catalysts are preferably balanced to achieve desirable properties in the polyurethane elastomer.

It is contemplated that paint may be used in conjunction with the present invention and that the polyurethane elastomer may be applied to it. If the paint is used in conjunction with the present invention, the dynamic interaction between the first and the second catalysts decreases a paint adhesion time, of the polyurethane elastomer. A decreased paint adhesion time of less than 2 minutes allows finished articles to be demolded at cycle times consistent with automotive interior production demands. Catalysis must be fine tuned to allow the isocyanate enough time to react with isocyanate reactive groups in the paint, as well as with the isocyanate reactive groups in the resin composition. Without intending to be bound by any particular theory, it is believed that the paint adhesion time is decreased due to catalysis of a reaction of the isocyanate and hydroxyl or amine groups in the paint. The paint adhesion time will be described in greater detail below.

The dynamic interaction also decreases a de-molding time, and facilitates a formation of the polyurethane elastomer having improved tensile strength, Graves Tear Strength and elongation. Decreased de-molding time increases the efficiency of forming the polyurethane elastomer and increases efficiency. Without intending to limit the scope of the present invention, it is believed that the de-molding time is decreased because the dynamic interaction between the first and second catalysts increases the rate of the reaction of the polyol with the isocyanate. The de-molding time will be described in greater detail below.

Improved tensile strength of the polyurethane elastomer reduces a chance that the polyurethane elastomer may fail. Improved Graves Tear Strength of the polyurethane elastomer reduces a possibility that the polyurethane elastomer may tear. Improved elongation of the polyurethane elastomer increases a chance that the polyurethane elastomer may be flexible. Improved tensile strength and Graves Tear Strength in addition to elongation, of the polyurethane elastomer, increase marketability of the polyurethane elastomer.

Without intending to limit the scope of the present invention, it is believed that the tensile strength, Graves Tear Strength, and elongation are achieved through effective catalysis of primary reaction between the polyol and the isocyanate and a minimization of the reaction between water and humidity and the isocyanate. The tensile strength, Graves Tear Strength, and elongation will be described in further detail below.

The elastomeric urethane composition may also include an additive or a plurality of additives. Preferably, the additive is selected from the group of chain extenders, anti-foaming agents, processing additives, chain terminators, surface-active agents, adhesion promoters, flame retardants, anti-oxidants, dyes, ultraviolet light stabilizers, fillers, thixotropic agents, and combinations thereof.

More preferably, the additive includes a chain extender as an additive. Examples of preferred chain extenders include compounds having two functional groups with active hydrogen atoms including, but not limited to, hydrazine, primary and secondary diamines, alcohols, amino acids, hydroxy acids, glycols, and combinations thereof. Such chain extenders typically have a number average molecular weight of less than about 400 g/mol. However, chain extenders with number average molecular weights of greater than 400 g/mol are also contemplated for use. More preferably, the chain extender is selected from the group of ethylene glycol, 1,4-butanediol, diethyltoluene diamine, 1,3-butanediol, propylene glycol, dipropylene glycol, diethylene glycol, glycerine and combinations thereof. Most preferably, the chain extender is selected from the group of 1,4-butanediol, 1,3-butanediol, ethylene glycol and combinations thereof. 1,3-butanediol is commercially available from GE Silicones of Wilton, Conn., under the trade name of NIAX Processing Additive DP-1022.

Chain extenders typically act as polymer hard-segment forming agents upon reaction with isocyanates and improve physical characteristics of the polyurethane elastomer. While an amount of chain extender included in the elastomeric urethane composition is, in large part determined by an anticipated end use of the polyurethane elastomer, the elastomeric urethane composition preferably includes of from 1 to 20 more preferably of from 6 to about 15, and most preferably of from 8 to about 10, parts by weight of the chain extender per 100 parts by weight of the resin composition.

The elastomeric urethane composition also preferably includes an anti-foaming agent as an additive. The anti-foaming agent preferably includes a silicone liquid commercially available from Dow Corning of Midland, Mich., under the trade name of Antifoam-A. The anti-foaming agent typically acts to break an interface of gaseous carbon dioxide bubbles formed from the reaction of water and humidity with the isocyanate. If included in the elastomeric urethane composition, the anti-foaming agent is preferably included in an amount of from 0.01 to 0.50 and most preferably of from 0.05 to 0.15, parts by weight of the anti-foaming agent per 100 parts by weight of the resin composition.

The elastomeric urethane composition may also include a chain terminator as an additive. If the chain terminator is included, the chain terminator preferably includes an alcohol. More preferably, the chain terminator includes a primary alcohol. Most preferably, the chain terminator includes a blend of C₁₂, C₁₃, C₁₄ and C₁₅ high purity primary alcohols commercially available from Shell Chemicals of Houston, Tex., under the trade name of Neodol® 25. If included in the elastomeric urethane composition, the chain terminator is preferably included in an amount of from 1 to 6, more preferably of from 2 to 4, and most preferably 3, parts by weight of the chain terminator per 100 parts by weight of the resin composition.

In one embodiment of the present invention, the elastomeric urethane composition is substantially free of particulates. The particulates that are minimized and preferably eliminated in this embodiment, typically include, but are not limited to, solids, air releasing agents, wetting agents, surface modifiers, waxes, inert inorganic fillers, reactive inorganic fillers, fumed silica, molecular sieves, chopped glass, glass mat, and combinations thereof. More typically, the particulates in this embodiment include reactive and inert inorganic fillers, fumed silica, and molecular sieves. Most typically, the particulates in this embodiment include fumed silica and molecular sieves. It is to be understood that substantially free, as related to this embodiment, preferably includes an amount of particulates in the elastomeric urethane composition of less than 1., more preferably of less than 0.50, and most preferably of less than 0.05, parts by weight of the particulates per 100 parts by weight of the resin composition.

Referring now to the article first introduced above, the article preferably includes the first layer formed from the elastomeric urethane composition. More specifically, the first layer preferably includes the polyurethane elastomer that is formed from the reaction of the resin composition and the isocyanate. The first layer preferably has a consistent surface texture and is durable, both of which contribute to the usability of the first layer.

Depending largely on the intended use of the first layer, the thickness of the first layer is preferably of from 0.5 to 10, more preferably of from 1 to 3, and most preferably of from 1.5 to 2.5, mm. Further, the first layer preferably has a density of from 718 to 1200 and more preferably of from 908 to 1130, kg/M³. The first layer also preferably has an elongation of greater than 100, and more preferably of greater than 250, %, as determined by ASTM D412. The first layer also preferably has a tensile strength of greater than 500, more preferably of greater than 1200, and most preferably of greater than 1500, psi, as determined by ASTM D412. Also, the first layer preferably has a Graves Tear Strength of greater than 60, and more preferably of greater than 120, pounds per linear inch, as determined by ASTM D624.

The article also preferably includes a second layer disposed on the first layer. The second layer may be disposed in contact with the first layer or may be separated from the first layer. The second layer preferably includes a urethane composition different from the elastomeric urethane composition and acts as a support layer. Most preferably, the second layer includes a foamed urethane composition. The urethane composition can be modified in density, crush resistance and other important characteristics. As such, the density of the urethane composition can be controlled independently of the density of the polyurethane elastomer. Urethane compositions that are considered useful for forming the second layer include those disclosed in U.S. Pat. Nos. 4,389,454 and 5,512,319, which are hereby expressly incorporated by reference.

The article also preferably includes a third layer disposed on the first layer, which may be sprayed into a mold. The third layer may be disposed in contact with the first layer or may be separated from the first layer. The third layer may also be disposed on the second layer, if the second layer is included in the present invention. The third layer may be disposed in contact with the second layer or may be separated from the second layer. The third layer, if included in the article, is formed from a paint. The paint may include, but is not limited to, latex-based paints, urethane-based paints, water-based paints, polyester-based paints, acrylic-based paints, and combinations thereof.

The article may also include additional layers. If additional layers are included in the article, the additional layers are preferably the same as the second layer, described above. However, additional layers that are different from the second layer and different from the first layer are also contemplated for use in the present invention. If additional layers are included, the additional layers may be disposed on either the first, second, and/or third layers, and may be disposed in contact with the first, second, and/or third layers or may be separated from the first, second, and/or third layers.

In one embodiment of the present invention, the article includes the door bolster, first described above. Preferably, the door bolster includes the first layer formed from the elastomeric urethane composition. The door bolster also preferably includes the second layer formed from the foamed urethane composition. The door bolster is preferably used in automotive applications.

The present invention also provides an elastomeric urethane system. The elastomeric urethane system includes the resin composition comprising the polyol, the isocyanate reactive with the resin composition, and the first and second catalysts, described above. Like the elastomeric urethane composition described above, the elastomeric urethane system may also include a second polyol, and one or a plurality of additives, the same as those described above.

The present invention further provides a method for making the article in the mold having a mold cavity. Initially, the mold cavity is preferably coated with a known mold release agent by spraying to facilitate an eventual demolding of the article. However, the mold release agent may be applied to the mold cavity by other methods including pouring, or inclusion in a coating composition having a predetermined color. If utilized, the mold release agent may include, but is not limited to, silicones, soaps, waxes, solvents, and combinations thereof.

Alternatively, or in addition to the application of the mold release agent, a coating composition having a predetermined color may be sprayed or poured into the mold cavity. The coating composition may be selected from a variety of water and solvent borne solutions. For example, the coating composition may include a one or multi-component composition including enamel or elastomeric urethane compositions, with the latter being particularly preferred. Among the numerous available coating compositions which are suitable for use in the present invention, the most preferred coating compositions for use in the present invention include Protothane®, commercially available from Titan Finishes Corporation of Detroit, Mich., Polane®, commercially available from Sherwin Williams, Inc. of Cleveland, Ohio, and Rimbond®, commercially available from Lilly Corporation of Aurora, Ill.

The method includes reacting the resin composition to form the elastomeric urethane composition, wherein the resin composition and the isocyanate are reacted in the presence of the first and second catalysts. The method also includes applying the elastomeric urethane composition, described above, to the mold cavity and allowing the elastomeric urethane composition to cure to form the first layer, also described above. To form the first layer, the polyol, the isocyanate, and the first and second catalysts are preferably mixed by impingement mixing in a head of a spray gun wherein the polyol and the isocyanate are preferably reacted to form the polyurethane elastomer. The polyurethane elastomer is preferably applied over the mold release agent and/or coating composition if present and, in the absence thereof, directly to the surface of the mold cavity. The elastomeric urethane composition may be sprayed or poured into the mold cavity. Preferably, the elastomeric urethane composition is sprayed into the mold cavity. As understood by those skilled in the art, the amount of water and humidity present in the mold cavity is an important condition to be considered when making the composite structure. Preferably, the amount of water and humidity is minimized to reduce any possible foaming of the polyurethane elastomer. However, because of the first catalyst, some water and humidity may be present in the production environment without adversely affecting the reaction of isocyanate reactive components of the resin composition with the isocyanate. Preferably, the elastomeric urethane composition is applied to the mold cavity in the presence of less than 17, more typically of less than 14, and most typically of less than 7, g/m³ absolute humidity.

The method also includes applying the urethane composition, described above, to the mold cavity to form the second layer, also described above. Preferably, the second layer serves as the support layer to the first layer and preferably includes a foamed urethane composition. As such, the urethane composition may be applied to the first layer directly, i.e., in contact with the first layer. The second layer is preferably applied to the mold cavity after the first layer is applied to the mold cavity. However, the second layer may be applied to the mold cavity before the first layer is applied. The second layer may also be applied over the mold release agent and/or coating composition if present and, in the absence thereof, directly to the surface of the mold cavity. It is contemplated that the second layer may be sprayed, injected, or poured into the mold cavity. Most preferably, the second layer is sprayed into the mold cavity.

If the first and/or second layers are sprayed into the mold cavity, spray processing parameters may be manipulated to ensure the quality of the first and second layers. The spray processing parameters that are typically manipulated include, but are not limited to, a temperature of the elastomeric urethane composition and any additional components, a pressure of the elastomeric urethane composition entering the spray gun, and a throughput of the spray gun. If the temperature of the elastomeric urethane composition is manipulated, the temperature is preferably maintained between 25 and 85, and more preferably between 55 and 74,° C. Similarly, if the pressure of the elastomeric urethane composition entering the spray gun is manipulated, the pressure is preferably maintained between 700 and 1500, and more preferably between 900 and 1100, psi. Also, if the throughput of the spray gun is manipulated, the throughput is preferably maintained between 5 and 50, and most preferably between 17 and 40, g/sec.

The method also includes curing the article in the mold cavity. Preferably, the article is cured for 20 to 180 seconds, more preferably of from 30 to 90 seconds, and most preferably of from 45 to 70 seconds. Also, the article is preferably cured at a temperature of 35 to 110, more preferably of 45 to 80, and most preferably of 55 to 75, ° C. The method further includes demolding the article from the mold cavity.

### EXAMPLES

A series of polyurethane elastomers, Polyurethane Elastomers 1 and 2, were formed using the elastomeric polyurethane composition of the present invention. Water was added to the elastomeric polyurethane composition with an assumption that the water would minimally react with the isocyanate in the presence of the first and second catalysts of the present invention and no formation of gaseous carbon dioxide would result. It was believed that addition of water to the elastomeric urethane composition would allow a water stable first catalyst along with its specificity and reactivity to be identified. The first catalyst is a metal and a ligand and the second catalyst is an amine. Varying the amount of each catalyst and observing differences in rise heights allowed the specificity of the catalyst to be identified. If the first and second catalysts of the present invention minimally catalyzed the reaction of the isocyanate with the water, foaming would be very low. As illustrated, Elastomers 1 and 2 exhibit a low measurement of rise height.

A series of comparative polyurethane elastomers, Polyurethane Elastomers 3 through 11, were also formed. The Polyurethane Elastomers 3 through 11 were formed using an comparative elastomeric urethane composition including the polyol and the isocyanate of the present invention, and catalysts known in the art. The catalysts used in the comparative elastomeric urethane included amine catalysts used alone, and bismuth and tin catalysts. Water was also added to the comparative elastomeric urethane compositions. The bismuth and tin catalysts are known to promote the reaction of the isocyanate with water. As such, the comparative elastomeric urethane compositions were formed to illustrate a difference in foaming and rise heights of the Polyurethane Elastomers 3 through 11, as compared to Polyurethane Elastomers 1 and 2.

Both the Polyurethane Elastomers 1 and 2 and the comparative Polyurethane Elastomers 3 through 11 were independently formed from a mechanically mixed combination including 69.85 parts by weight of a Polyol A, 20.15 parts by weight of a Polyol B, 10 parts by weight of a short-chain chain extender, and 0.27 parts by weight of water, based on 100 parts by weight of resin composition.

For each of Polyurethane Elastomers 1 and 2, 132.7 grams of the resin composition were combined with the first and second catalysts of the present invention, a zirconium chelate catalyst and dimethylaminopropylurea, respectively, in varying amounts, as set forth in Table 1. After the first and second catalysts were added to resin composition, as set forth in Table 1, the resin composition was mechanically mixed for five seconds using a 3″ German mix blade at 3100 rpm and allowed to rest for 55 seconds. After resting for 55 seconds, 67.3 grams of an isocyanate was added to the resin composition such that the isocyanate index was 100, not including a contribution from water. The total weight of the resin composition after addition of the isocyanate is 200 grams, not including the weight of the catalysts added. After adding the isocyanate, the resin composition was mechanically mixed for an additional 5 seconds.

For each of Polyurethane Elastomers 3 through 11, 132.7 grams of the resin composition were prepared. Individual portions of the resin composition for Polyurethane Elastomers 3 through 11 were removed from the resin composition and the amine, bismuth, and tin catalysts were individually added to the individual portions, in the same manner as the catalysts described above, such that one catalyst was added to each of the individual portions. After the catalysts were added, the isocyanate was added to each of the individual portions, also in the same manner and in the same proportions as the isocyanate described above. The individual portions for Polyurethane Elastomers 3 through 11 were mechanically mixed for the same time as the resin composition, described above.

After the isocyanate was added to the resin composition and the individual portions for Polyurethane Elastomers 3 through 11, the mixtures of the polyol, isocyanate, chain extender, water, and catalysts were allowed to cure for 16 hours at 70° F. and de-molded, thereby forming the completed Polyurethane Elastomers 1 through 11. Upon curing, a rise height of the Polyurethane Elastomers 1 through 11 was measured. The rise height quantitatively indicated the amount of gaseous carbon dioxide formed in the Polyurethane Elastomers 1 through 11 from the reaction of water with the isocyanate. The rise heights resulting from using the first and second catalysts of the present invention in comparison to using the amine, bismuth and tin catalysts individually are also set forth in Table 1. The results illustrate an advantage to using the first and second catalysts of the present invention. The first and second catalysts of the present invention showed less catalysis of the reaction of water with the isocyanate as indicated by the lower rise heights of the Polyurethane Elastomers 1 and 2 as compared to the higher rise heights of the Polyurethane Elastomers 3 through 11. In Table 1, all weights are in grams added to the total of 200 g of the resin composition and the isocyanate, unless otherwise stated.

TABLE 1

| | | | Amount of | Rise | Gel Time @ |
|---|---|---|---|---|---|
| | Catalyst | | Catalyst | Height | 65° C. |
| Elastomer | Name | Catalyst Type | (g) | (in) | (sec) |
| Series of | | First and Second | | | |
| Polyurethane | | Catalysts of the Present | | | |
| Elastomers | | Invention | | | |
| 1 | King XC | Zirconium Chelate | 0.05 | 3.3 | 55 |
| | 9213 | | | | |
| | NE-1070 | Dimethylaminopropylurea | 1.30 | — | — |
| 2 | King XC | Zirconium Chelate | 0.1 | 3 | 43 |
| | 9213 | | | | |
| | NE-1070 | Dimethylaminopropylurea | 1.29 | — | — |
| Series Of | | | | | |
| Comparative | | | | | |
| Polyurethane | | | | | |
| Elastomers | | Other Catalysts | | | |
| 3 | NE-1070 | Dimethylaminopropylurea | 0.51 | 3.9 | >200 |
| 4 | NE-1070 | Dimethylaminopropylurea | 3.19 | 4.5 | 49 |
| 5 | XC C227 | Bismuth | 0.36 | 5.1 | >200 |
| 6 | XC C227 | Bismuth | 2 | 4.9 | 41 |
| 7 | Dabco | Bismuth | 0.15 | 5.3 | >200 |
| | MB20 | | | | |
| 8 | Dabco | Bismuth | 0.56 | 5.3 | 65 |
| | MB20 | | | | |
| 9 | King XC | Bismuth | 0.6 | 5.1 | 48 |
| | b221 | | | | |
| 10 | King XC | Bismuth | 1.14 | 4.3 | 18 |
| | b221 | | | | |
| 11 | UL-22 | Tin | 0.22 | 3.6 | 27 |

The zirconium chelate, as the first catalyst, is commercially available from King Industries, Inc. of Norwalk, Conn., under the trade name of K-Kat® XC-9213.

The dimethylaminopropylurea, as the second catalyst, is commercially available from Air Products and Chemicals, Inc. of Allentown, Pa., under the trade name of DABCO® NE-1070.

Polyol A, commercially available from BASF Corporation of Wyandotte, Mich., under the trade name of Pluracol® 816, includes an ethylene oxide cap of 16.5% by weight based on the total weight of the polyol, and has a number average molecular weight of 4800 g/mol, a hydroxyl number of 35 mg KOH/g, and a calculated functionality of 2.59.

Polyol B, commercially available from BASF Corporation of Wyandotte, Mich., under the trade name of Pluracol® 1062, includes an ethylene oxide cap of 18% by weight based on the total weight of the polyol, and has a number average molecular weight of 4000 g/mol, a hydroxyl number of 29 mg KOH/g, and a calculated functionality of 1.80.

The isocyanate, commercially available from BASF Corporation of Wyandotte, Mich., under the trade name of Lupranate® MP102, includes a % NCO content of 23% by weight, and a calculated functionality of 2.

The short-chain chain extender is 1,4-butane diol.

The present invention was further evaluated as additional polyurethane elastomers, Polyurethane Elastomers 12 through 14, were formed using the elastomeric urethane composition of the present invention. The Polyurethane Elastomers 12 through 14 were formed because the Polyurethane Elastomers 1 through 11, as set forth in Table 1, included an addition of the catalysts to the wet resin composition before addition of the isocyanate, resulting in slower reactions between polyol and the isocyanate. The Polyurethane Elastomers 12 through 14 were formed via mechanically mixing a series of individual portions for Polyurethane Elastomers 12 through 14 including 200 grams of the elastomeric urethane composition and 0.5 grams of water. The elastomeric urethane composition used to form Polyurethane Elastomers 12 through 14 included polyol A, polyol B, the isocyanate, the short-chain chain extender, the first catalyst, dimethylaminopropylurea as the second catalyst, a third catalyst, a molecular sieve, and an anti-foaming agent, as set forth in Table 2. The individual portions for Polyurethane Elastomers 12 through 14 were allowed to cure for 16 hours at 70° F. and de-molded, thereby forming the Polyurethane Elastomers 12 through 14. All parts are parts by weight based on the total weight of the resin composition, unless otherwise stated.

TABLE 2

| | | Poly- | Poly- | Poly- |
|---|---|---|---|---|
| | | Urethane | Urethane | Urethane |
| | | Elastomer | Elastomer | Elastomer |
| | Component | 12 | 13 | 14 |
| Resin Composition | Polyol A | 70.27 | 70.27 | 70.27 |
| | Polyol B | 16.91 | 16.91 | 16.91 |
| | Chain Extender | 10 | 10 | 10 |
| | Molecular Sieve | 1 | 1 | 1 |
| | Anti-Foaming Agent | 0.1 | 0.1 | 0.1 |
| | Fumed Silica | 0.65 | 0.65 | 0.65 |
| | Third Catalyst | 0.05 | 0.05 | 0.05 |
| | Total | 98.98 | 98.98 | 98.98 |
| Isocyanate | Isocyanate (g) per 100 g of | 51.37 | 51.37 | 51.37 |
| | the resin composition | | | |
| | NCO % | 22.9 | 22.9 | 22.9 |
| | Weight Ratio | 0.519 | 0.519 | 0.519 |
| | Isocyanate Index | 100 | 100 | 100 |
| First Catalyst | Zirconium (IV) | 0.019 | 0 | 0 |
| | tetrakis(2,2,6,6- | | | |
| | tetramethyl-3,5- | | | |
| | heptanedionate) | | | |
| | Zirconium (IV) | 0 | 0.025 | 0 |
| | Acetylacetonate | | | |
| | Iron Acetylacetonate | 0 | 0 | 0.025 |
| Second Catalyst | Dimethylaminopropylurea | 0.50 | 0.50 | 0.50 |
| Rise Height (in) | | 3.7 | 4.1 | 3.3 |
| Gel Time @ 65° C. | | 27 | 14 | 8 |
| (sec) | | | | |

Polyol A and Polyol B, the chain extender, the isocyanate, and the dimethylaminopropylurea, as set forth in Table 2, are the same as polyol A and Polyol B, the short-chain extender, the isocyanate, and the dimethylaminopropylurea that are described above.

The molecular sieve is commercially available from Advanced Specialty Gases of Reno, Nev., under the trade name of Molecular Sieve 3A.

The anti-foaming agent is a silicone liquid and is commercially available from Dow Corning of Midland, Mich., under the trade name of Antifoam-A.

The third catalyst is a delayed-action, heat-activated catalyst based on 1,8 diaza-bicyclo (5,4,0) undecene-7 commercially available from Air Products and Chemicals, Inc. of Allentown, Pa., under the trade name of Polycat® SA-102.

The fumed silica is commercially available from Degussa AG of Düsseldorf, Germany, under the trade name of Aerosil® R972.

The zirconium (IV) tetrakis(2,2,6,6-tetramethyl-3,5-heptanedionate), the zirconium (IV) acetylacetonate, and the iron acetylacetonate, as the first catalyst, are each commercially available from Sigma Aldrich, Inc. of Norwalk, Conn.

The percent NCO is the percent by weight of the NCO groups of the isocyanate accomplished by a standard chemical titration analysis known to those skilled in the art.

The isocyanate index is defined as 100 times the ratio of the number of isocyanate (NCO) groups in the isocyanate to the number of isocyanate reactive (OH, NH) groups in the resin composition

The weight ratio is the ratio of the parts by weight of the isocyanate mixed with the parts by weight of the resin composition.

The results of the rise height and the gel time measurements indicate that the zirconium (IV) tetrakis(2,2,6,6-tetramethyl-3,5-heptanedionate), the zirconium (IV) acetylacetonate, and the iron acetylacetonate, used as the first catalyst, along with the dimethylaminopropylurea as the second catalyst, caused the rise height of the Polyurethane Elastomers 12 through 14 to be low which corresponds to a reduction of the reaction of water and humidity and the isocyanate.

After the rise heights and gel times of the Polyurethane Elastomers 12 through 14 were determined, the zirconium (IV) acetylacetonate, as the first catalyst, and dimethylaminopropylurea as the second catalyst, were used to form yet another series of polyurethane elastomers, Polyurethane Elastomers 15 through 24. The Polyurethane Elastomers 15 through 24 were formed via mechanically mixing a series of individual portions for Polyurethane Elastomers 15 through 24 including 100 parts by weight of the resin composition, including polyol B, a Polyol C, the short-chain chain extender, the molecular sieve, the anti-foaming agent, the first catalyst, the second catalyst, and fumed silica, as set forth in Table 3. The individual portions also included the isocyanate as set forth in Table 3. However, a first individual portion used to form Polyurethane Elastomers 15 through 19 included a different amount of the second catalyst than a second individual portion used to form Polyurethane Elastomers 20 through 24, with the second individual portion including a lesser amount of the second catalyst than the first individual portion.

The first and second individual-portions for Polyurethane Elastomers 15 through 19 and Polyurethane Elastomers 20 through 24, respectively, were allowed to cure for less than five minutes at 165° F. and de-molded, thereby forming the Polyurethane Elastomers 15 through 24. The Polyurethane Elastomers 15 through 24 were tested for paint adhesion time and demolding time, as determined by visual inspection. All parts are parts by weight based on the total weight of the resin composition, unless otherwise stated.

TABLE 3

| | | Poly- | Poly- | Poly- | Poly- |
|---|---|---|---|---|---|
| | | Urethane | Urethane | Urethane | Urethane |
| | | Elastomer | Elastomer | Elastomer | Elastomer |
| | Component | 15 | 16 | 17 | 18 |
| Resin Composition | Polyol B | 16.91 | 16.91 | 16.91 | 16.91 |
| | Polyol C | 70.32 | 70.32 | 70.32 | 70.32 |
| | Chain Extender | 10 | 10 | 10 | 10 |
| | Molecular Sieve | 1 | 1 | 1 | 1 |
| | Anti-Foaming | 0.1 | 0.1 | 0.1 | 0.1 |
| | Agent | | | | |
| | Fumed Silica | 0.65 | 0.65 | 0.65 | 0.65 |
| | First Catalyst | 0.025 | 0.025 | 0.025 | 0.025 |
| | Second Catalyst | 1 | 1 | 1 | 1 |
| | Total | 100.0 | 100.0 | 100.0 | 100.0 |
| Isocyanate | Isocyanate (g) per | 50.20 | 51.50 | 52.80 | 54.10 |
| | 100 g of the resin | | | | |
| | composition | | | | |
| | NCO % | 22.9 | 22.9 | 22.9 | 22.9 |
| | Weight Ratio | .502 | .515 | .528 | .541 |
| | Isocyanate Index | 95 | 97.5 | 100 | 102.5 |
| Ambient | | 75 | 75 | 75 | 75 |
| Temperature (° F.) | | | | | |
| Relative | | 33 | 33 | 33 | 33 |
| Humidity (%) | | | | | |
| Paint | | 90 | 90 | 90 | 90 |
| Adhesion | | | | | |
| Time (sec) | | | | | |
| Demolding | | 60 | 60 | 60 | 60 |
| Time (sec) | | | | | |
| | | Poly- | Poly- | Poly- | Poly- |
| | | Urethane | Urethane | Urethane | Urethane |
| | | Elastomer | Elastomer | Elastomer | Elastomer |
| | Component | 19 | 20 | 21 | 22 |
| Resin Composition | Polyol B | 16.91 | 16.91 | 16.91 | 16.91 |
| | Polyol C | 70.32 | 71.32 | 71.32 | 71.32 |
| | Chain Extender | 10 | 10 | 10 | 10 |
| | Molecular Sieve | 1 | 0.5 | 0.5 | 0.5 |
| | Anti-Foaming | 0.1 | 0.1 | 0.1 | 0.1 |
| | Agent | | | | |
| | Fumed Silica | 0.65 | 0.65 | 0.65 | 0.65 |
| | First Catalyst | 0.025 | 0.025 | 0.025 | 0.025 |
| | Second Catalyst | 1 | 0.5 | 0.5 | 0.5 |
| | Total | 100.0 | 100.0 | 100.0 | 100.0 |
| Isocyanate | Isocyanate (g) per | 55.50 | 49.20 | 50.50 | 51.70 |
| | 100 g of the resin | | | | |
| | composition | | | | |
| | NCO % | 22.9 | 22.9 | 22.9 | 22.9 |
| | Weight Ratio | .555 | .492 | .505 | .517 |
| | Isocyanate Index | 105 | 95 | 97.5 | 100 |
| Ambient | | 75 | 74 | 74 | 74 |
| Temperature (° F.) | | | | | |
| Relative | | 33 | 22 to 33 | 22 to 33 | 22 to 33 |
| Humidity (%) | | | | | |
| Paint | | 90 | >120 | >120 | >120 |
| Adhesion | | | | | |
| Time (sec) | | | | | |
| Demolding | | 60 | 120 | 120 | 120 |
| Time (sec) | | | | | |

| | | Poly- | Poly- |
|---|---|---|---|
| | | Urethane | Urethane |
| | | Elastomer | Elastomer |
| | Component | 23 | 24 |
| Resin | Polyol B | 16.91 | 16.91 |
| Composition | Polyol C | 71.32 | 71.32 |
| | Chain Extender | 10 | 10 |
| | Molecular Sieve | 0.5 | 0.5 |
| | Anti-Foaming | 0.1 | 0.1 |
| | Agent | | |
| | Fumed Silica | 0.65 | 0.65 |
| | First Catalyst | 0.025 | 0.025 |
| | Second Catalyst | 0.5 | 0.5 |
| | Total | 100.0 | 100.0 |
| Isocyanate | Isocyanate (g) per | 52.90 | 54.30 |
| | 100 g of the resin | | |
| | composition | | |
| | NCO % | 22.9 | 22.9 |
| | Weight Ratio | .529 | .543 |
| | Isocyanate Index | 102.5 | 105 |
| Ambient | | 74 | 74 |
| Temperature | | | |
| (° F.) | | | |
| Relative | | 22 to 33 | 22 to 33 |
| Humidity | | | |
| (%) | | | |
| Paint | | >120 | >120 |
| Adhesion | | | |
| Time (sec) | | | |
| Demolding | | 120 | 120 |
| Time (sec) | | | |

Polyol B, the short-chain chain extender, the molecular sieve, the anti-foaming agent, the fumed silica, the second catalyst, and the isocyanate, as set forth in Table 3, are the same as polyol B, the short-chain chain extender, the molecular sieve, the anti-foaming agent, the fumed silica, the second catalyst, and the isocyanate, described above.

Polyol C, commercially available from BASF Corporation of Wyandotte, Mich., under the trade name of Pluracol® 538, includes an ethylene oxide cap of 12.5% by weight based on the total weight of the polyol, and has a number average molecular weight of 6000 g/mol, a hydroxyl number of 35 mg KOH/g, and a calculated functionality of 2.57.

The first catalyst is zirconium (IV) acetylacetonate commercially available from Sigma Aldrich, Inc. of Norwalk, Conn.

The results of the paint adhesion time determination, as set forth above in Table 3, illustrates that the first and second catalysts used to form Polyurethane Elastomers 15 through 24 allow polyurethane elastomers, in general, to be formed in environments having humidity while maintaining an acceptable paint adhesion time.

The results of the demolding time determinations, also set forth above in Table 3, illustrate advantages to using the first and second catalysts of the present invention. The first and second catalysts allowed the Polyurethane Elastomers 15 through 24 to be demolded in short period of time. Shortening the demolding time reduces overall production costs.

The present invention was still further evaluated as another series of elastomers, Polyurethane Elastomers 25 through 34, was also formed. The Polyurethane Elastomers 25 through 34 were formed via mechanically mixing a series of individual portions for Polyurethane Elastomers 25 through 34 including 100 parts by weight of the resin composition, including polyol B, polyol C, the short-chain chain extender, the molecular sieve, the anti-foaming agent, and the fumed silica, as set forth in Table 4. The individual portions also included the isocyanate, the first catalyst, and the second catalyst, as set forth in Table 4. The resin composition along with the isocyanate and the first and second catalysts included in the individual portions for Polyurethane Elastomers 25 through 34 are the same as the resin composition described above in Table 3 as related to first and second individual portions used to form Polyurethane Elastomers 15 through 19 and Polyurethane Elastomers 20 through 24, respectively.

However, the individual portions used to form Polyurethane Elastomers 25 through 29 included a different amount of the second catalyst than the individual portions used to form Polyurethane Elastomers 30 through 34, with the individual portions used to form Polyurethane Elastomers 30 through 34 including a greater amount of the second catalyst than the individual portions used to form Polyurethane Elastomers 25 through 29. Each of Polyurethane Elastomers 25 through 34 was independently formed at different isocyanate indices using the isocyanate, as described above. Specifically, the isocyanate was added to each of the individual portions used to form Polyurethane Elastomers 25 through 34 in differing proportions such that the each of the isocyanate indices of the Polyurethane Elastomers 25 through 34 independently ranged between 95 and 105, as further set forth in Table 4.

TABLE 4

| | | Poly- | Poly- | Poly- | Poly- |
|---|---|---|---|---|---|
| | | Urethane | Urethane | Urethane | Urethane |
| | | Elastomer | Elastomer | Elastomer | Elastomer |
| | Component | 25 | 26 | 27 | 28 |
| Resin Composition | Polyol B | 16.90 | 16.90 | 16.90 | 16.90 |
| | Polyol C | 70.30 | 70.30 | 70.30 | 70.30 |
| | Chain Extender | 10 | 10 | 10 | 10 |
| | Molecular Sieve | 1 | 1 | 1 | 1 |
| | Anti-Foaming | 0.1 | 0.1 | 0.1 | 0.1 |
| | Agent | | | | |
| | Fumed Silica | 0.65 | 0.65 | 0.65 | 0.65 |
| | First Catalyst | .05 | .05 | .05 | .05 |
| | Second Catalyst | 1 | 1 | 1 | 1 |
| | Total | 100.0 | 100.0 | 100.0 | 100.0 |
| Isocyanate | Isocyanate (g) per | 50.20 | 51.50 | 52.80 | 54.10 |
| | 100 g of resin | | | | |
| | composition | | | | |
| | NCO % | 22.9 | 22.9 | 22.9 | 22.9 |
| | Weight Ratio | 0.502 | 0.515 | 0.528 | 0.541 |
| | Isocyanate Index | 95 | 97.5 | 100 | 102.5 |
| | | Poly- | Poly- | Poly- | Poly- |
| | | Urethane | Urethane | Urethane | Urethane |
| | | Elastomer | Elastomer | Elastomer | Elastomer |
| | Component | 29 | 30 | 31 | 32 |
| Resin Composition | Polyol B | 16.90 | 16.90 | 16.90 | 16.90 |
| | Polyol C | 70.30 | 69.80 | 69.80 | 69.80 |
| | Chain Extender | 10 | 10 | 10 | 10 |
| | Molecular Sieve | 1 | 1 | 1 | 1 |
| | Anti-Foaming | 0.1 | 0.1 | 0.1 | 0.1 |
| | Agent | | | | |
| | Fumed Silica | 0.65 | 0.65 | 0.65 | 0.65 |
| | First Catalyst | .05 | .05 | .05 | .05 |
| | Second Catalyst | 1 | 1.5 | 1.5 | 1.5 |
| | Total | 100.0 | 100.0 | 100.0 | 100.0 |
| Isocyanate | Isocyanate (g) per | 55.50 | 51.30 | 52.60 | 54 |
| | 100 g of resin | | | | |
| | composition | | | | |
| | NCO % | 22.9 | 22.9 | 22.9 | 22.9 |
| | Weight Ratio | 0.555 | .513 | .526 | .540 |
| | Isocyanate Index | 105 | 95 | 97.5 | 100 |

| | | Poly- | Poly- |
|---|---|---|---|
| | | Urethane | Urethane |
| | | Elastomer | Elastomer |
| | Component | 33 | 34 |
| Resin | Polyol B | 16.90 | 16.90 |
| Composition | Polyol C | 69.80 | 69.80 |
| | Chain Extender | 10 | 10 |
| | Molecular Sieve | 1 | 1 |
| | Anti-Foaming | 0.1 | 0.1 |
| | Agent | | |
| | Fumed Silica | 0.65 | 0.65 |
| | First Catalyst | .05 | .05 |
| | Second Catalyst | 1.5 | 1.5 |
| | Total | 100.0 | 100.0 |
| Isocyanate | Isocyanate (g) per | 55.30 | 56.70 |
| | 100 g of resin | | |
| | composition | | |
| | NCO % | 22.9 | 22.9 |
| | Weight Ratio | .553 | .567 |
| | Isocyanate Index | 102.5 | 105 |

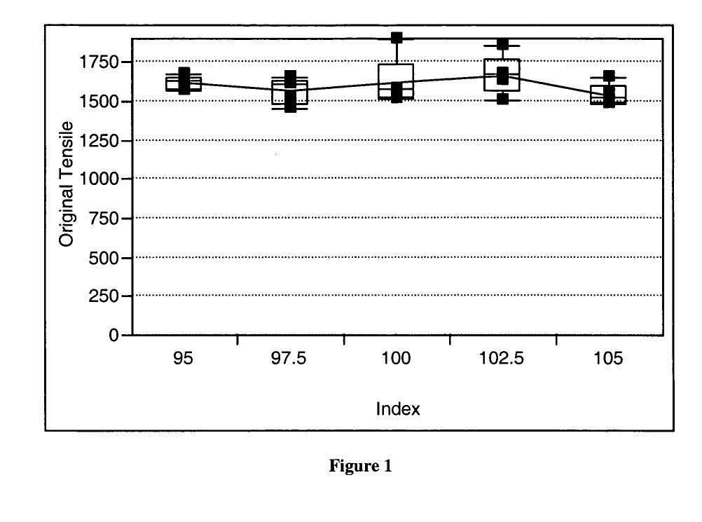

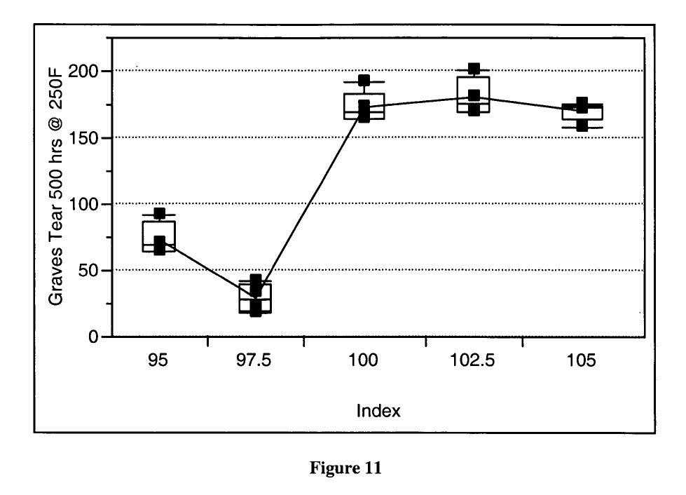

Samples of each of the Polyurethane Elastomers 25 through 34 were evaluated for tensile strength, elongation, and Graves Tear Strength, as determined by ASTM D412, ASTM D412, and ASTM D624, respectively. The results of these evaluations are presented in FIGS. 1 through 12 as distribution graphs created using the statistical software package JMP®, as is well known in the art.

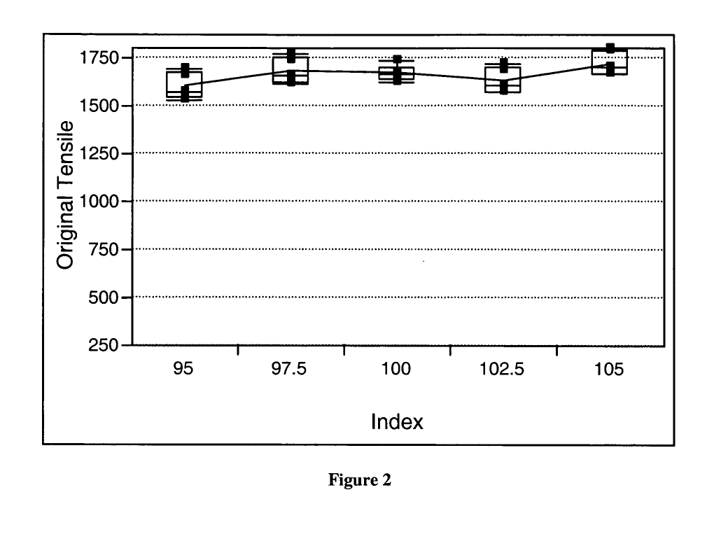

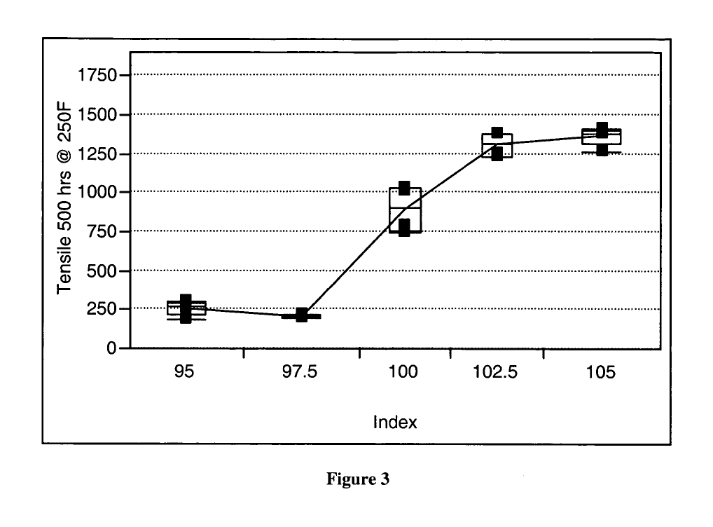

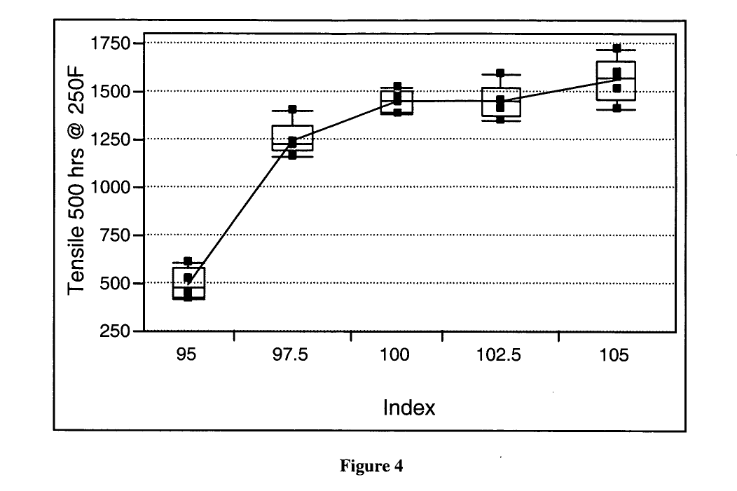

The tensile strength evaluations were made to determine a maximum stress that each of the Polyurethane Elastomers 25 through 34 could withstand, while subjected to a stretching load, without breaking. The tensile strength evaluations were made both before and after heat treatment of the elastomers. Specifically, five samples of each of the Polyurethane Elastomers 25 through 29 and Polyurethane Elastomers 30 through 34 were evaluated for tensile strength without heat treatment, at room temperature, as seen in FIGS. 1 and 2, respectively. Also, five samples of each of the Polyurethane Elastomers 25 through 29 and Polyurethane Elastomers 30 through 34 were evaluated for tensile strength after heat treatment at 250° F. for 500 hours, as seen in FIGS. 3 and 4, respectively.

The tensile strength evaluations at room temperature illustrate that the first and second catalysts allow the Polyurethane Elastomers 25 through 29 and Polyurethane Elastomers 30 through 34 to have average tensile strengths of greater than 1500 psi, as seen in FIGS. 1 and 2, respectively. The tensile strengths of greater than 1500 psi minimize possible breaking of the Polyurethane Elastomers 25 through 34, which is desirable.

The tensile strength evaluations after heat treatment also illustrate an advantage to using the first and second catalysts. The first and second catalysts allowed the Polyurethane Elastomers 25 through 29, after heat treatment, to have an increasing tensile strength with increasing isocyanate index, as seen in FIG. 3. The first and second catalysts also allowed the Polyurethane Elastomers 30 through 34 to have an increased tensile strength with an increased isocyanate index, as seen in FIG. 4. Polyurethane Elastomers 30 through 34 exhibited a higher average tensile strength, after heat treatment, than the Polyurethane Elastomers 25 through 29, as seen in FIGS. 4 and 3, respectively. A benefit of using the Polyurethane Elastomers 25 through 29 and especially Polyurethane Elastomers 30 through 34 includes maintaining a suitable tensile strength. If used in automobile applications such as in door bolsters, the Polyurethane Elastomers 25 through 34 could provide a desirable level of tensile strength thereby reducing a chance that a surface of the door bolster may break.

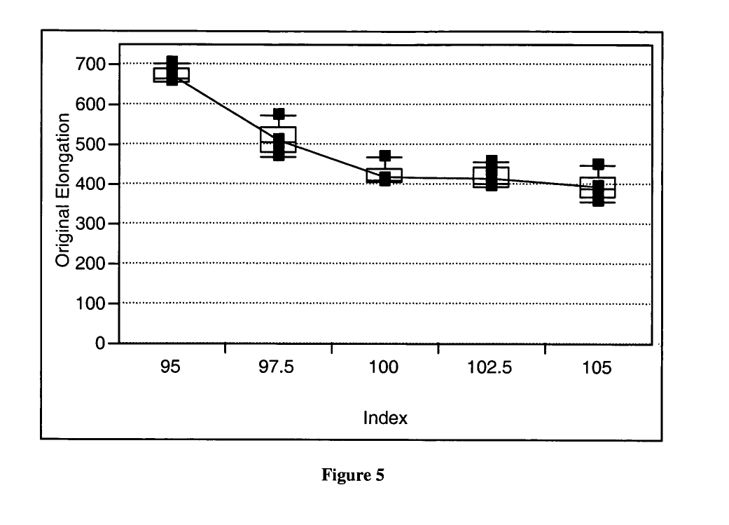

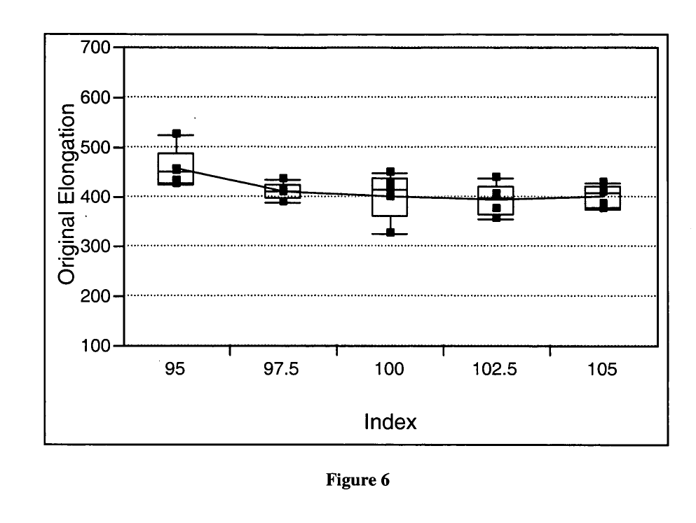

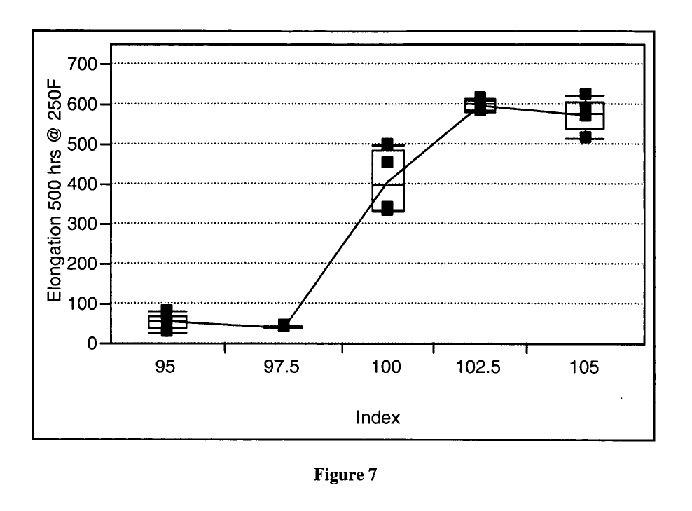

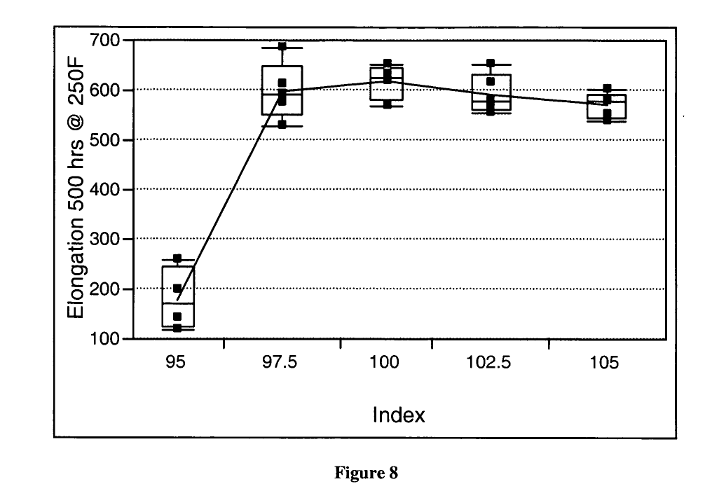

The elongation evaluations were made to determine an increase in a length of Polyurethane Elastomers 25 through 34 due to tension applied. The elongation evaluations, like the tensile strength evaluations, were made both before and after heat treatment of the elastomers. Specifically, five samples of each of the Polyurethane Elastomers 25 through 29 and Polyurethane Elastomers 30 through 34 were evaluated for elongation without heat treatment, at room temperature, as seen in FIGS. 5 and 6, respectively. Also, five samples of each of the Polyurethane Elastomers 25 through 29 and Polyurethane Elastomers 30 through 34 were evaluated for elongation after heat treatment at 250° F. for 500 hours, as seen in FIGS. 7 and 8, respectively.

The elongation evaluations at room temperature illustrate that the first and second catalysts allow the Polyurethane Elastomers 25 through 29 to have elongations of from 400 to 700%, as seen in FIG. 5. The Polyurethane Elastomers 30 through 34 were shown to have elongations of from 400 to 500%, as seen in FIG. 6. The elongation of the Polyurethane Elastomers 25 through 29 and Polyurethane Elastomers 30 through 34 decreased with increasing isocyanate index, as seen in FIGS. 5 and 6, respectively. If paint is applied to the polyurethane elastomer, then elongation of greater than 400% maximizes a possibility that the Polyurethane Elastomers 30 through 34 will have minimal rigidity and will stretch, which is desirable to maximize a chance that the polyurethane elastomer will stretch at least as much as the paint and therefore the paint will not delaminate.

The elongation evaluations after heat treatment also illustrate an advantage to using the first and second catalysts. The first and second catalysts allowed the Polyurethane Elastomers 27, 28, 29, and 31 through 34 to have a desirable level of elongation thereby additionally maximizing a possibility of that the Polyurethane Elastomers 27, 28, 29, and 31 through 34 will have minimal rigidity and will stretch if used in the door bolster.

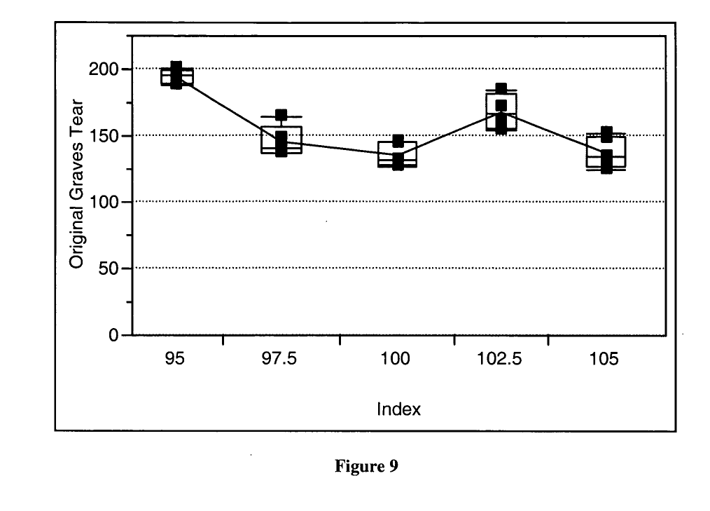

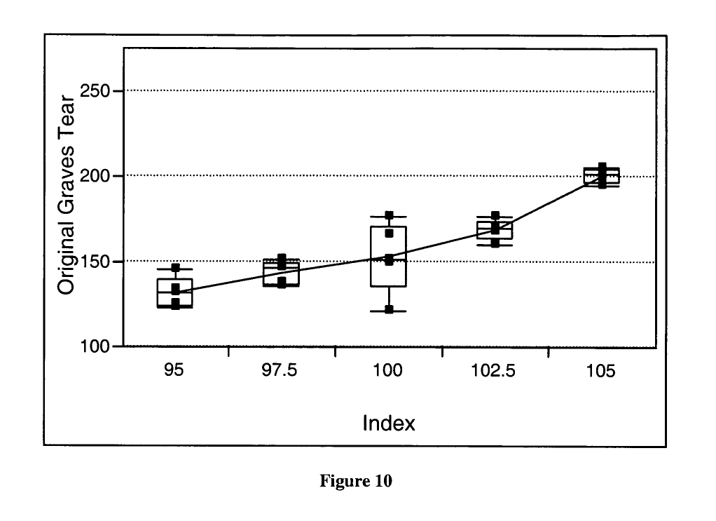

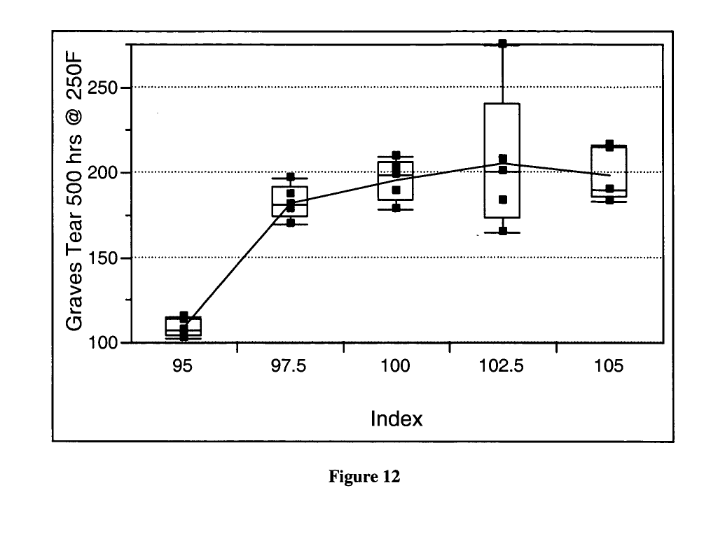

The Graves Tear Strength evaluations were made to determine a force need to rupture the Polyurethane Elastomers 25 though 34 by pulling a prepared notched sample. The Graves Tear Strength evaluations, like the elongation and tensile strength evaluations, were made both before and after heat treatment of the elastomers. Specifically, five samples of each of the Polyurethane Elastomers 25 through 29 and Polyurethane Elastomers 30 through 34 were evaluated for Graves Tear Strength without heat treatment, at room temperature, as seen in FIGS. 9 and 10, respectively. Also, five samples of each of the Polyurethane Elastomers 25 through 39 and Polyurethane Elastomers 30 through 34 were evaluated for Graves Tear Strength after heat treatment at 250° F. for 500 hours, as seen in FIGS. 1 and 12, respectively.

The Graves Tear Strength evaluations at room temperature illustrate an advantage to using the first and second catalysts. The first and second catalysts allowed the Polyurethane Elastomers 25 through 34 to have a Graves Tear Strength that would minimize a possibility of tearing and splitting, which is also desirable.

The results of the Graves Tear Strength evaluations after heat treatment also illustrate an advantage to using the first and second catalysts. The first and second catalysts allowed the Graves Tear Strength to increase with increasing the isocyanate index. If used in door bolsters, the Polyurethane Elastomers 27, 28, 29, and 31 through 34 could provide a desirable level of Graves Tear Strength thereby reducing a possibility of tearing or splitting of the door bolster.

Obviously, many modifications and variations of the present invention are possible in light of the above teachings. The invention may be practiced otherwise than as specifically described within the scope of the appended claims.

What is claimed is:

1. An elastomeric urethane composition comprising the reaction product of:
a resin composition comprising a polyol; and
an isocyanate,
wherein said resin composition and said isocyanate are reacted in the presence of;
a first catalyst comprising a metal selected from the group of iron, titanium, zirconium, and hafnium, and
a second catalyst comprising an amine.

2. An elastomeric urethane composition as set forth in claim 1 wherein said polyol is selected from the group of a polyetherol, a polyesterol, a polycaprolactone, and combinations thereof.

3. An elastomeric urethane composition as set forth in claim 1 wherein said polyol comprises a polyetherol having a number average molecular weight of from 3,000 to 8,000 g/mol, a hydroxyl number of from 20 to 50 mg KOH/g, a calculated functionality of from 2 to 4, and an ethylene oxide cap of from 10 to 20% by weight based on the total weight of said polyol.

4. An elastomeric urethane composition as set forth in claim 1 wherein said polyol comprises an organic functional group selected from the group of a carboxyl group, an amine group, a carbamate group, an amide group, and an epoxy group.

5. An elastomeric urethane composition as set forth in claim 1 wherein said isocyanate comprises an aromatic isocyanate.

6. An elastomeric urethane composition as set forth in claim 5 wherein said aromatic isocyanate has a % NCO content of from 10 to 30% by weight, and a calculated functionality of from 1.9 to 3.

7. An elastomeric urethane composition as set forth in claim 5 wherein said isocyanate is selected from the group of 2,4′-diphenylmethane diisocyanate, 4,4′-diphenylmethane diisocyanate, modified 2,4′-diphenylmethane diisocyanate, modified 4,4′-diphenylmethane diisocyanate, and combinations thereof.

8. An elastomeric urethane composition as set forth in claim 1 wherein said resin composition and said isocyanate are reacted at an isocyanate index of from 95 to 105.

9. An elastomeric urethane composition as set forth in claim 1 wherein said first catalyst is further defined as having the general structure: 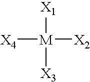
wherein M is selected from the group of iron, titanium, zirconium, and hafnium, and
wherein each of X₁, X₂, X₃, and X₄ are ligands and each are independently selected from the group of a diketone having the general structure:
R¹COCHCOR²
wherein each of R¹ and R² are independently selected from the group of a branched hydrocarbon and a linear hydrocarbon.

10. An elastomeric urethane composition as set forth in claim 9 wherein each of said ligands X₁, X₂, X₃, and X₄ are 2,4-pentanedionate or 2,2,6,6-tetramethyl-3,5-heptanedionate.

11. An elastomeric urethane composition as set forth in claim 1 wherein said first catalyst is present in said elastomeric urethane composition in an amount of from 0.03 to 0.07 parts by weight per 100 parts by weight of said resin composition.

12. An elastomeric urethane composition as set forth in claim 1 wherein said first catalyst is blended with said resin composition prior to reaction with said isocyanate.

13. An elastomeric urethane composition as set forth in claim 1 wherein said second catalyst is blended with said resin composition prior to reaction with said isocyanate.

14. An elastomeric urethane composition as set forth in claim 1 wherein said second catalyst is present in said elastomeric urethane composition in an amount of from 0.5 to 3 parts by weight per 100 parts by weight of said resin composition.

15. An elastomeric urethane composition as set forth in claim 1 wherein said amine is selected from the group of dimethylaminopropylurea, 1-ethyl-3-(3-dimethylaminopropyl)urea, 2-propenoic acid, 2-methyl-2-[[[[(3-dimethylamino)propyl]amino]carbonyl]amino]ethyl ester, and combinations thereof.

16. An elastomeric urethane composition as set forth in claim 15 wherein said amine comprises dimethylaminopropylurea.

17. An elastomeric urethane composition as set forth in claim 1 wherein said resin composition further comprises an additive selected from the group of chain extenders, anti-foaming agents, processing additives, chain terminators, surface-active agents, adhesion promoters, flame retardants, anti-oxidants, dyes, ultraviolet light stabilizers, fillers, thixotropic agents, and combinations thereof.

18. An elastomeric urethane composition as set forth in claim 1 further comprising a second polyol.

19. An elastomeric urethane composition as set forth in claim 1 wherein said polyol comprises an ethylene oxide cap from 12 to 18% by weight based on the total weight of said polyol; said polyol has a number average molecular weight of from 3,000 to 8,000 g/mol; and said polyol has a hydroxyl number of from 20 to 50 mg KOH/g.

20. An elastomeric urethane composition as set forth in claim 19 wherein said isocyanate is selected from the group of 2,4′-diphenylmethane diisocyanate, 4,4′-diphenylmethane diisocyanate, modified 2,4′-diphenylmethane diisocyanate, modified 4,4′-diphenylmethane diisocyanate, and combinations thereof.

21. An elastomeric urethane composition as set forth in claim 20 wherein said first catalyst is further defined as having the general structure: 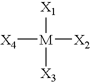
wherein M is selected from the group of iron and titanium; and
wherein each of X₁, X₂, X₃, and X₄ are ligands and include 2,4-pentanedionate.

22. An elastomeric urethane composition as set forth in claim 21 wherein said amine comprises dimethylaminopropylurea.

23. An article comprising a first layer formed from said elastomeric urethane composition of claim 1.

24. An article as set forth in claim 23 further comprising a second layer disposed on said first layer wherein said second layer comprises a urethane composition different from said elastomeric urethane composition.

25. An article as set forth in claim 23 further comprising a third layer disposed on said first layer wherein said third layer is formed from a paint.

26. An elastomeric urethane system comprising:
a resin composition comprising a polyol;
an isocyanate,
a first catalyst comprising a metal selected from the group of iron, titanium, zirconium, and hafnium, and
a second catalyst comprising an amine.

27. A method of making an article in a mold having a mold cavity, said method comprising the steps of:
a) reacting a resin composition comprising a polyol, and an isocyanate, to form an elastomeric urethane composition,
wherein said resin composition and said isocyanate are reacted in the presence of;
1) a first catalyst comprising a metal selected from the group of iron, titanium, zirconium, and hafnium, and
2) a second catalyst comprising an amine;
b) applying the elastomeric urethane composition to the mold cavity and allowing the elastomeric urethane composition to cure to form a first layer;
c) applying a urethane composition different from the elastomeric urethane composition to the mold cavity to form a second layer;
d) curing the article in the mold cavity; and
e) demolding the article from the mold cavity.

28. A method of making an article as set forth in claim 27 wherein the urethane composition comprises a foamed urethane composition.
